(19) United States
(12) Patent Application Publication
(10) Pub. No.: US 2008/0187133 A1
(43) Pub. Date: Aug. 7, 2008

(54) ENCRYPTION CODE PROCESSING CIRCUIT, OPERATION DEVICE AND ELECTRONIC APPARATUS

(75) Inventor: Isao Akima, Ogaki (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/022,244

(22) Filed: Jan. 30, 2008

(30) Foreign Application Priority Data
Feb. 1, 2007 (JP) 2007-022675

(51) Int. Cl. H04L 9/28

(52) U.S. Cl. 380/28

(57) ABSTRACT

An encryption processing circuit includes: a rewritable ferroelectric memory including an encryption table containing one or more data codes paired with encryption codes that are the data codes encrypted, a first region for storing the encryption codes, and a second region for storing the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region.

The entire disclosure of Japanese Patent Application No. 2007-022675, filed Feb. 1, 2007 is expressly incorporated by reference herein.

### BACKGROUND

1. Technical Field

The invention relates to encryption code processing circuits, operation devices and electronic apparatuses, which are provided with security functions.

2. Related Art

A micro processing unit (MPU) in prior art 1000 directly writes a program code, which is stored in an external program memory 160 without being encrypted, to a program memory 110 of the MPU 1000 and executes the program, as shown in FIG. 5. Therefore, there is a danger that the program code may be misused because it can be readily decrypted through accessing the program memory 110.

To address the issue described above, for example, a non-patent document, “Fujitsu Semiconductor Device FRAM Guidebook MN05-00009-4” on page 17 (http://edevice.fujitsu.com/jp/manual/MANUALp/ja-pdf/MN05-00009-4.pdf) describes a method including providing an encryption coprocessor 300, as shown in FIG. 6, encrypting a program to be stored in a program memory 110 of an MPU 1000, decrypting the encryption code by the encryption coprocessor 300, and executing the program.

However, according to the non-patent document described above, the encryption coprocessor 300 includes a program storage ROM (or RAM) that fixedly stores encryption correspondence history data (including encryption key or decryption key information) for encryption and decryption for a relatively long period of time until a next communication event with the outside occurs and an event to change the encryption processing program takes place, and a logic circuit for fixed encryption processing. If the data storing the encryption history is kept in a standby state in which a decryption event does not occur (the data is kept fixedly stored), and addresses are successively inputted on the wirings of the program storage ROM, the stored data can be outputted and their relations can be examined. By so doing, the encryption correspondence (including encryption key or decryption key information) history and the encryption processing information can be relatively readily deciphered. Therefore there is a danger that the stored program may be deciphered with malicious intent, as a result, the stored encryption (including encryption key or decryption key information) history table can be readily deciphered, and the stored program may be falsified. Moreover, for changing the encryption correspondence (including encryption key or decryption key information) history and the encryption processing information stored in the ROM, the encryption coprocessor 300 needs to be operated to perform processings each time such a change is made, and encryption correspondence data and an encryption (including encryption key or decryption key information) history table need to be recreated each time in a result data storage RAM. This means that, if the history (including encryption key or decryption key information) and the encryption processing information are exposed, an illegal creation of a false encryption (including encryption key or decryption key information) history table for misuse cannot be avoided. Furthermore, an ordinary RAM cannot secure sufficient reliability against destruction or deterioration of stored information, which may be caused by the occurrence of an abnormal use environment such as an interruption of the power supply during the above-described process or during storage of the result data.

### SUMMARY

An advantage of some aspects of the invention, encryption processing circuits, processor devices and electronic apparatuses are provided with an encryption code correspondence table that can be readily updated and cannot be decrypted from outside.

An encryption processing circuit in accordance with an embodiment of the invention includes: a rewritable ferroelectric memory including an encryption table containing one or more data codes paired with encryption codes that are the data codes encrypted, a first region for storing the encryption codes, and a second region for storing the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region.

According to the composition described above, the encryption table is written in the ferroelectric memory that is rewritable at very high speeds, such that it is easy to continue properly rewriting the encryption table relation at high speeds with the cache function of the encryption table given between the encryption table and the storage memory according to the encryption rule of the encryption table itself, and the stored data and stored data history (including encryption key or decryption key information) stored in the ferroelectric memory can be continuously rewritten. Therefore, there is in effect no risk of the encryption table stored in the ferroelectric memory being decrypted from outside. Even if the data were artificially decrypted temporarily for unauthorized use, the encryption table relation can be repeatedly recovered to the state where the encryption table itself should originally be by the cache function of the encryption table given between the encryption table and the storage memory, such that the encryption table that is about to be misused would be overwritten, and therefore there is no danger of the encryption table stored in the ferroelectric memory being continuously misused from outside. Further, upon detecting the occurrence of a condition in which the encryption table and stored data relation cannot be established due to malicious intent, the characteristics of the ferroelectric memory may be used thereby stopping the use of the encryption table itself. Accordingly, the invention can provide a function to stop and prevent misuse of the device.

In the encryption processing circuit in accordance with an aspect of the embodiment of the invention, the ferroelectric memory may include an error correction circuit that corrects an error that possibly occurs on data stored in the ferroelectric memory.

By the composition described above, even when an encryption code that is transferred to the first region of the ferroelectric memory has an error, there is no danger of malfunction because the error is corrected.

An operation device in accordance with an embodiment of the invention includes: a rewritable ferroelectric memory including an encryption table containing one or more command codes paired with encryption codes that are the command codes encrypted, a first region for storing the encryption codes, and a second region for storing the command codes, wherein, when the encryption code is stored in the first region, the encryption table is searched through and the command code pairing with the encryption code is outputted to the second region, and when the command code is stored in the second region, the encryption table is searched through, and the encryption code paring with the command code is outputted to the first region; a program memory for storing one or more of the encryption codes; a command register to which the encryption codes are successively transferred from the program memory; a command decoder to which, after the encryption code transferred to the command register is inputted to the first region of the ferroelectric memory, the command code outputted to the second region of the ferroelectric memory is transferred; and an arithmetic logic operation unit that executes an arithmetic logic operation based on the command code transferred to the command decoder.

According to the composition described above, the encryption table is written in the ferroelectric memory that is rewritable at very high speeds, such that it is easy to continue properly rewriting the encryption table relation at high speeds with the cache function of the encryption table given between the encryption table and the storage memory according to the encryption rule of the encryption table itself, and the stored data and stored data history (including encryption key or decryption key information) stored in the ferroelectric memory can be continuously rewritten. Therefore, there is in effect no risk of the encryption table stored in the ferroelectric memory being decrypted from outside. Even if the data were artificially decrypted temporarily for unauthorized use, the encryption table relation can be repeatedly recovered to the state where the encryption table itself should originally be by the cache function of the encryption table given between the encryption table and the storage memory, such that the encryption table that is about to be misused would be overwritten, and therefore there is no danger of the encryption table stored in the ferroelectric memory being continuously misused from outside. Further, upon detecting the occurrence of a condition in which the encryption table and stored data relation cannot be established due to malicious intent, the characteristics of the ferroelectric memory may be used thereby stopping the use of the encryption table itself. Accordingly, the invention can provide a function to stop and prevent misuse of the device.

In the operation device in accordance with an aspect of the embodiment of the invention, the ferroelectric memory may include an error correction circuit that corrects an error that possibly occurs on data stored in the ferroelectric memory.

By the composition described above, even when an encryption code that is transferred to the first region of the ferroelectric memory has an error, there is no danger of malfunction because the error is corrected.

The operation device in accordance with an aspect of the embodiment of the invention may input the command code read from outside to the second region of the ferroelectric memory, and write the encryption code outputted to the first region of the ferroelectric memory to the program memory.

By the composition described above, command codes are encrypted by the same encryption table, such that there is no possibility of malfunction.

Also, an electronic apparatus in accordance with an embodiment of the invention includes the operation device described above.

### BRIEF DESCRIPTION OF THE DRAWINGS

FIG. 1 is a schematic block diagram of the composition of an operation device in accordance with a first embodiment of the invention.

FIGS. 2A and 2B show diagrams for describing the composition of an encryption table.

FIG. 3 is a block diagram for describing an operation to encrypt command codes.

FIG. 4 is a block diagram for describing an operation to rewrite an encryption table.

FIG. 5 is a schematic block diagram of the composition of an operation device in related art.

FIG. 6 is a schematic block diagram of the composition of an operation device provided with an encryption coprocessor in related art.

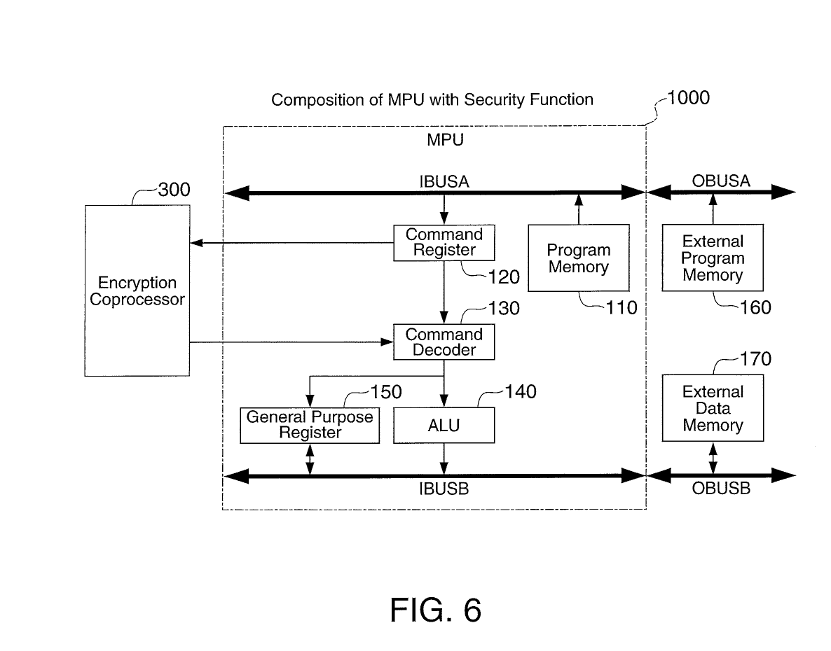

### DESCRIPTION OF EXEMPLARY EMBODIMENTS

Preferred embodiments of the invention are described below with reference to the accompanying drawings.

### First Embodiment

Composition of Operation Device

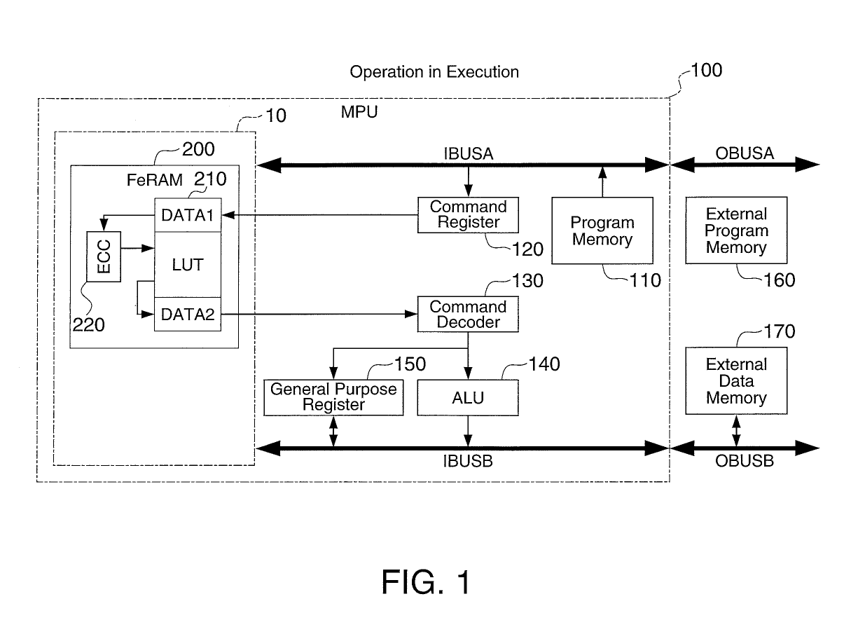

First, the composition of an operation device in accordance with the first embodiment is described with reference to FIG. 1. FIG. 1 is a schematic block diagram of the composition of the operation device in accordance with the first embodiment of the invention. As shown in FIG. 1, a MPU 100 that is an operation device includes a program memory 110, a command register 120, a command decoder 130, an arithmetic and logic unit (ALU) 140, a general purpose register 150, an encryption processing circuit 10 that includes a FeRAM (Ferroelectric Random Access Memory) 200, and internal buses IBUSA and IBUSB.

The FeRAM 200 is a type of a nonvolatile memory using a ferroelectric. The ferroelectric is a dielectric material (a substance that stores a charge by polarization and does not flow a direct current) whose orientation of spontaneous polarization (a phenomenon in which electrically positive or negative state occurs in the substance) can be freely changed by the application of a voltage, and its orientation of polarization can be continually maintained without the application of a voltage. Furthermore, the FeRAM 200 is capable of high-speed reading and writing 10 times or higher than flash memories, and its reliability is said to be considerably higher than flash memories and EEPROM (Electronically Erasable and Programmable Read Only Memory).

The FeRAM 200 has advantages such as high-speed access capability, high reliability and nonvolatility in which data is stored without the application of a voltage, as described above. Furthermore, a ferroelectric is used as a memory element, stored data would be destroyed if the data is carelessly read out, which makes the data difficult to be read from outside. For this reason, high security and reliability can be provided by writing an encryption table LUT for decoding encryption codes in the data storage region 210 of the FeRAM 200.

The program memory 110 is composed of a flash memory by which data can be freely erased or written and its content is not lost when the power supply is interrupted, and stores a series of encryption codes that are encrypted command codes written therein. The program memory 110 transfers by a program counter (not shown) the next encryption code to be executed to the command register 120 through the interior bus IBUSA.

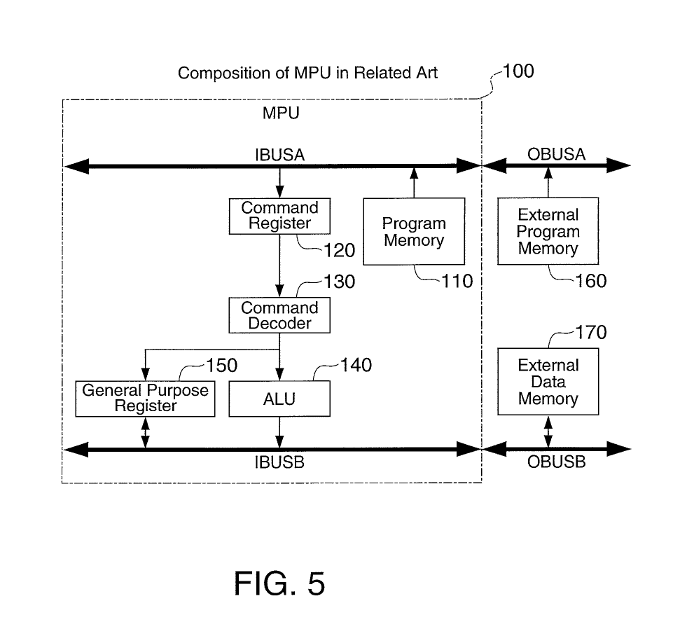

Upon receiving the encryption code, the command register 120 transfers the same to the FeRAM 200, but not to the command decoder 130 like the MPU 1000 in related art (shown in FIG. 5).

The FeRAM 200 includes a data storage region 210 and an error correction circuit (ECC: Error Correction Code) 220. Also, an encryption table LUT (Lookup Table) for decoding encryption codes to data codes is written in the data storage region 210. Upon receiving the encryption code transferred from the command register 120 at a region DATA1 that is the first region of the data storage region 210, the FeRAM 200 refers to the encryption table LUT, writes a command code paring with the encryption code to a region DATA2 that is the second region of the data storage region 210, and transfers the command code to the command decoder 130.

The command decoder 130 interprets the command code transferred, and the ALU 140 with the general purpose register 150 executes a command stipulated by the command code.

Composition of LUT

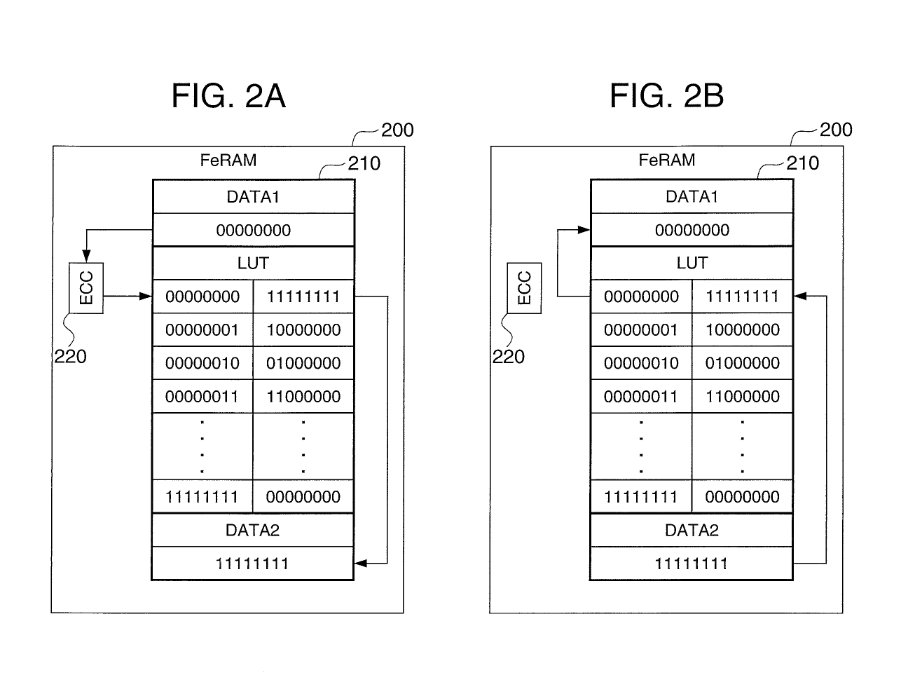

The composition of the encryption table LUT is described below with reference to FIGS. 2A and 2B. FIGS. 2A and 2B are diagrams for describing the composition of the encryption table LUT. FIG. 2A shows the composition showing operations in which an encryption code is decoded to a command code, and FIG. 2B shows the composition showing operations in which a command code is encrypted to an encryption code. It is noted that numerical values shown in FIGS. 2A and 2B indicate an embodiment example of simple encryption.

As shown in FIG. 2A and 2B, the data storage region 210 of the FeRAM 200 includes the encryption table LUT, the region DATA1, and the region DATA2. The encryption table LUT has rows, and each of the rows has two regions, wherein the region on the left side stores an encryption code and the region on the right side stores a command code paired with the encryption code.

When decoding an encryption code to a command code, as shown in FIG. 2A, the encryption code is stored in the region DATA1, the encryption code stored in the region DATA1 is first checked with ECC 220 if it is correct, and when it is correct, a matching encryption code is searched through the left side regions of the encryption table LUT. When the matching encryption code is found, a command code in the right side regions to be paired with the encryption code is written out to the region DATA2.

When encrypting a command code to an encryption code, as shown in FIG. 2B, the command code is stored in the region DATA2, and a matching command code is searched through the right side regions of the encryption table LUT. When the matching command code is found, an encryption code in the left side regions to be paired with the command code is written to the region DATA1.

Operation to Encrypt Command Code

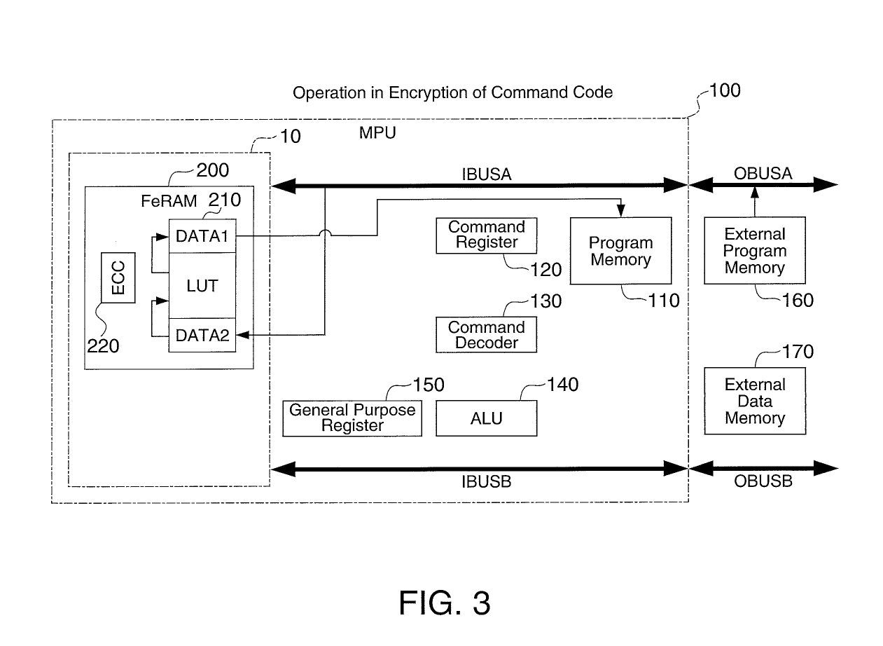

Next, an operation to encrypt a command code is described with reference to FIG. 3. FIG. 3 is a schematic block diagram for describing an operation to encrypt a command code.

As shown in FIG. 3, the MPU 100 is connected to external buses OBUSA and OBUSB, thereby connecting to an external program memory 160 that stores command codes before encryption, an external data memory 170 and the like. The command codes stored in the external program memory 160 are successively transferred to the region DATA2 of the data storage region 210 of the FeRAM 200 through the external bus OBUSA and the internal bus IBUSA. When the command code is received at the region DATA2 of the data storage region 210, the encryption table LUT is searched through, an encryption code pairing with the command code is written to the region DATA1 of the data storage region 210, and the command code is transferred to the program memory 110.

Operation to Rewrite LUT

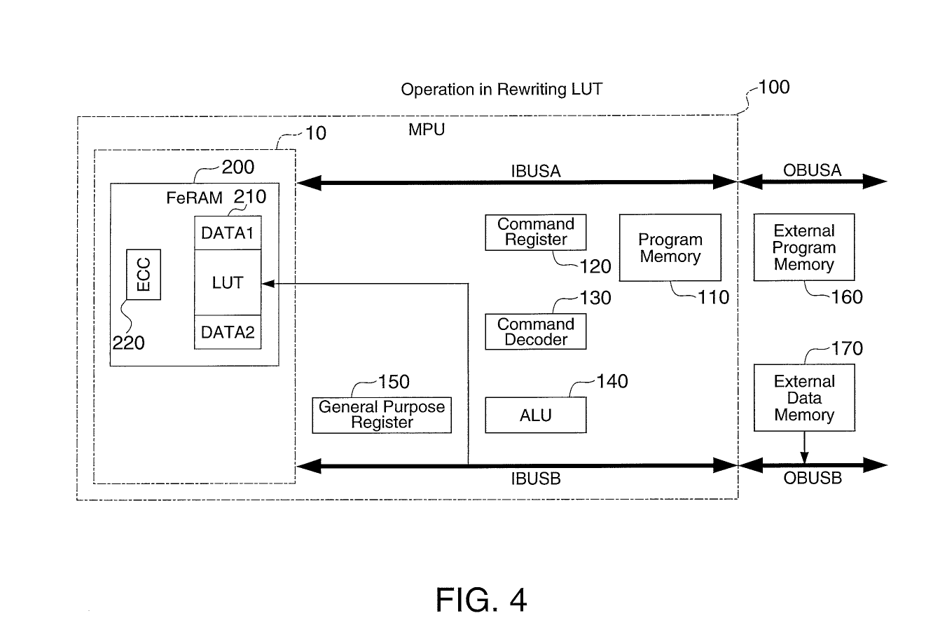

Next, an operation to rewrite the encryption table LUT is described with reference to FIG. 4. FIG. 4 is a block diagram for describing an operation to rewrite the encryption table LUT. A case in which the encryption table LUT is written to the external data memory 170 is described with reference to FIG. 4.

As shown in FIG. 4, the encryption table LUT stored in the external data memory 170 is transferred to the encryption table LUT of the data storage region 210 of the FeRAM 200 through the external bus OBUSB and the internal bus IBUSB, and rewritten there.

According to the embodiments described above, the following effects can be obtained.

In accordance with the embodiments described above, the encryption table is written in the ferroelectric memory, and therefore can be readily rewritten, and data stored in the ferroelectric memory is difficult to be encrypted from outside. Accordingly, it is possible to provide an operation device without the risk of an encryption table stored in a ferroelectric memory being read from outside.

Embodiments of the invention are described above, but the invention is not limited to those embodiments at all, and many changes can be made and implemented in a variety of modes within the range that does not depart from the subject matter of the invention. Some of the modified examples are described below.

### MODIFIED EXAMPLE 1

Operation devices in accordance with Modified Example 1 of the invention are described. Electronic apparatuses that use the operation device MPU 100 described in the first embodiment can be used in encryption data storage processing fields in diversified services with very low power consumption. For example, examples of the electronic apparatuses include information apparatuses such as cellular phones and PDA, and apparatuses using weak power supply such as electronic wristwatches and health meter watches.

What is claimed is:

1. An encryption processing circuit comprising:
a rewritable ferroelectric memory including an encryption table containing one or more data codes paired with encryption codes that are the data codes encrypted, a first region for storing the encryption codes, and a second region for storing the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region.

2. An encryption processing circuit according to claim 1, wherein the ferroelectric memory includes an error correction circuit that corrects an error that possibly occurs on data stored in the ferroelectric memory.

3. An operation device comprising:
a rewritable ferroelectric memory including an encryption table containing one or more command codes paired with encryption codes that are the command codes encrypted, a first region for storing the encryption codes, and a second region for storing the command codes, wherein, when the encryption code is stored in the first region, the encryption table is searched through, and the command code pairing with the encryption code is outputted to the second region, and when the command code is stored in the second region, the encryption table is searched through, and the encryption code pairing with the command code is outputted to the first region;
a program memory for storing one or more of the encryption codes;
a command register to which the encryption codes are successively transferred from the program memory;
a command decoder to which, after the encryption code transferred to the command register is inputted to the first region of the ferroelectric memory, the command code outputted to the second region of the ferroelectric memory is transferred; and
an arithmetic logic operation unit that executes arithmetic logic operation based on the command code transferred to the command decoder.

4. An operation device according to claim 3, wherein the ferroelectric memory includes an error correction circuit that corrects an error that possibly occurs on data stored in the ferroelectric memory.

5. An operation device according to claim 3, wherein the operation device inputs the command code read from outside to the second region of the ferroelectric memory, and writes the encryption code outputted to the first region of the ferroelectric memory to the program memory.

6. An electronic apparatus comprising the operation device recited in claim 3.
